(19) United States
(12) Patent Application Publication
(10) Pub. No.: US 2024/0398121 A1
(43) Pub. Date: Dec. 5, 2024

(54) FOLDABLE AIRPLANE COLLAPSIBLE ROCKING CHAIR

(71) Applicant: Jean-Francois Clavreul, Berkeley, CA (US)

(72) Inventor: Jean-Francois Clavreul, Berkeley, CA (US)

(21) Appl. No.: 18/205,739

(22) Filed: Jun. 5, 2023

(51) Int. Cl. A47C 4/10; A47C 5/14

(52) U.S. Cl. CPC A47C 4/10; A47C 5/14

(57) ABSTRACT

A collapsible chair in the shape of an aircraft or other object. The chair comprises a plurality of body elements and hinges that connect one or more of the body elements to one another. The chair is designed to lock in both a folded and deployed configuration. The transitioning from a folded to a deployed configuration and from a deployed back to a folded configuration comprises rotating one or more body elements around two different axes.

### FIELD

The present invention relates generally to a collapsible folding chair.

### BACKGROUND

Chairs are an important piece of daily life. They are used by everyone, from small children to the elderly. The time it takes to teach a child to properly use a chair may be impacted by many aspects of the design. Traditional chairs are often times bulky and difficult to transport or store.

### SUMMARY

The apparatus and methods described herein provide for the construction and operation of collapsible chair. In some embodiments, the collapsible chair may be a chair for kids and adults. The collapsible chair may comprise a left supporting side, a right supporting side, a left connecting element, a right connecting element, a seat, and a backrest. In some embodiments the collapsible chair may further comprise a hinge A, hinge B, hinge C, hinge D, hinge E, hinge F, hinge G, hinge H, hinge I and hinge J. Hinge A may be configured to pivotally connect the left connecting element to the left supporting side. Hinge B may be configured to pivotally connect the right connecting element to the right supporting side. Hinge C may be configured to pivotally connect the left connecting element to the right connecting element. Hinge C may also be substantially parallel and equidistant from hinge A and hinge B and oriented vertically.

In some embodiments, hinge D, may be configured to pivotally connect a main connecting element to the seat, wherein the main connecting element may be either the right connecting element or the left connecting element, Hinge D may also be oriented substantially perpendicular to hinge A and the hinge B when the chair is in a deployed configuration. Hinge D may also be oriented horizontally. Hinge H may be configured to pivotally connect the backrest to the main connecting element. Hinge H may also be substantially parallel to hinge D. In some embodiments, hinge D and hinge H may be the same hinge. In some embodiments, hinge D and Hinge H may be different hinges, oriented in the same manner but offset from one another.

In some embodiments, the left supporting side may further comprise a left lower supporting member and the right supporting side may comprise a right lower supporting member. The left lower supporting member and right lower supporting member may be in contact with the ground have an elliptical shape that enables a rocking movement when in use.

In some embodiments, the left supporting side may further comprise a left collapsible back element, wherein the left collapsible back element may be articulated with a substantially vertical hinge I. The right supporting side may further comprise a right collapsible back element, wherein the right collapsible back element may be articulated with a substantially vertical hinge J.

In some embodiments, the chair may further comprise one or more back element locking units, wherein the one or more back element locking units may be configured to hold the backrest in the deployed configuration. The chair may further comprise one or more seat locking units configured to hold the seat in the deployed configuration, preventing a scissoring movement.

In some embodiments, the backrest may further comprise a right locking slot 4B and a left locking slot 4A. The left locking slot 4A may be oriented perpendicular to, and overlapping the left collapsible back element when in the deployed configuration, rigidly joining the two pieces. The right locking slot 4B may be oriented perpendicular to, and overlapping the right collapsible back element when in the deployed configuration, rigidly joining the two pieces.

In some embodiments, the one or more seat locking units may comprise a spring loaded elbow latch, a spring bolt latch, a swing latch, a hook latch or a draw latch.

In some embodiments, the chair may further comprise a left additional connecting element and a right additional connecting element. The left additional connecting element may be pivotally connected to the left supporting side with hinge E. The right additional connecting element may be pivotally connected to the right supporting side with hinge F.

In some embodiments, hinge G, may be configured to pivotally connect the left additional connecting element and the right additional connecting element. The hinge G may also be substantially parallel and equidistant to hinge E and hinge F. Hinge G may also be oriented horizontally.

In some embodiments, the chair may be configured to transition from the deployed configuration to a folded configuration by performing a series of steps. The first step may comprise unlocking the seat and backrest, wherein the unlocking may further comprise: moving the backrest from a declined position to a vertical position, wherein the right locking slot and the left locking slot may hold the right collapsible back element and the left collapsible back element when in the deployed position and the right locking slot and the left locking slot may release the right collapsible back element and left collapsible element when transitioning to the folded configuration.

The second step may comprise disengaging the one or more seat locking units.

The third step may comprise folding the seat to a vertical position parallel to the backrest.

The fourth step may comprise transitioning the chair into the folded configuration, wherein the transitioning may comprise: rotating the seat and backrest about hinge A at the same time as rotating the left additional connecting element about hinge F and hinge G.

The transitioning may further be configured to simultaneously:

1. Bring the left supporting side and the right supporting side towards one another and parallel to the seat and backrest as well as rotate the left additional connecting element to be parallel and in contact with the left supporting side in a vertical position.

2. Rotate the right additional connecting element to be parallel and in contact with the right supporting side in a vertical position.

3. Rotate the left connecting element about hinge A and hinge C, and rotate the right connecting element about hinge B and hinge C to bring the right connecting element and left connecting element (6) into a position parallel and in contact with one another.

The fifth step may comprise rotating the left collapsible back element and the right collapsible back element to a position parallel and in contact with the left additional connecting element and the right additional connecting element, wherein the left collapsible back element and the right collapsible back element may be configured to rotate independently from the left supporting side and the right supporting side.

In some embodiments, the left additional connecting element may be further configured to extend past the left supporting side and the right additional connecting element may be further configured to extend past the right supporting side.

In some embodiments, the backrest may comprise a handle that facilitates the transport in both a folded configuration and the deployed configuration.

In some embodiments, the left collapsible back element and right collapsible back element both may comprise a winglet. The left collapsible back element and right collapsible back element may be locked together with the winglets when the chair is in its folded configuration to prevent opening the chair into the deployed configuration.

In some embodiments, the left supporting side, right supporting side, seat, backrest, right connecting element, left connecting element, left additional connecting element, right additional connecting element, left collapsible back element and right collapsible back element may be made of wood. In some embodiments the wood may be 3-axis CNC machined plywood. In some embodiments, hinges created by the hinges A-J may be made of metal. The metal may be made of stainless steel, and additional components like bushings and washers may be made of plastic. The plastic additional components may be inserted between the metal and the wood to avoid creaking and create controlled friction in the hinges.

In some embodiments, the left supporting element and right supporting element each may comprise a handle and a foot rests.

In some embodiments, the chair may be designed to have the shape of a transportation device.

In some embodiments, the chair may be designed to have the shape of an aircraft or an animal.

In some embodiments, the chair in its folded configuration may fit in a box with the dimensions of 19 inches by 19 inches by 5 inches, or 1 cuft, and may weigh less than 16 lbs, for a minimal storage space and standard ground shipping in the US.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating a 3-D view of an exemplary collapsible chair in a deployed configuration in which some embodiments may operate.

FIG. 2 is a diagram illustrating a 3-D view of an exemplary collapsible chair in a folded configuration in accordance with aspects of the present disclosure.

FIG. 3 is a diagram illustrating a top view of an exemplary collapsible chair in a folded configuration in accordance with aspects of the present disclosure.

FIG. 4 is a diagram illustrating a side view of an exemplary collapsible chair in a folded configuration in accordance with aspects of the present disclosure.

FIG. 5 is a diagram illustrating a bottom view of an exemplary collapsible chair in a folded configuration in accordance with aspects of the present disclosure.

FIG. 6 is a diagram illustrating an exploded view of an exemplary collapsible chair in a deployed configuration in accordance with aspects of the present disclosure.

FIG. 7 is a diagram illustrating an exploded view of an exemplary collapsible chair in a folded configuration in accordance with aspects of the present disclosure.

FIG. 8 is a diagram illustrating a bottom view of an exemplary collapsible chair in a deployed configuration in accordance with aspects of the present disclosure.

FIG. 9 is a diagram illustrating a side view of an exemplary collapsible chair in a deployed configuration in accordance with aspects of the present disclosure.

FIG. 10 is a diagram illustrating a back view of an exemplary collapsible chair in a deployed configuration in accordance with aspects of the present disclosure.

FIG. 11 is a diagram illustrating a front view of an exemplary collapsible chair in a deployed configuration in accordance with aspects of the present disclosure.

FIG. 12 is a diagram illustrating a 3-D view of an exemplary collapsible chair in transition from a deployed configuration to a folded configuration in accordance with aspects of the present disclosure.

FIG. 13 is a diagram illustrating a top view of an exemplary collapsible chair in transition from a deployed configuration to a folded configuration in accordance with aspects of the present disclosure.

FIG. 14 is a diagram illustrating a 3-D view of an exemplary collapsible chair in a deployed configuration in accordance with aspects of the present disclosure.

FIG. 15 is a diagram illustrating a 3-D view of an exemplary collapsible chair in a folded configuration in accordance with aspects of the present disclosure.

FIG. 16 is a diagram illustrating a front view of an exemplary collapsible chair in a folded configuration in accordance with aspects of the present disclosure.

FIG. 17 is a diagram illustrating a 3-D exploded view of an exemplary collapsible chair in a deployed configuration in accordance with aspects of the present disclosure.

FIG. 18 is a diagram illustrating a 3-D exploded view of an exemplary collapsible chair in a folded configuration in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

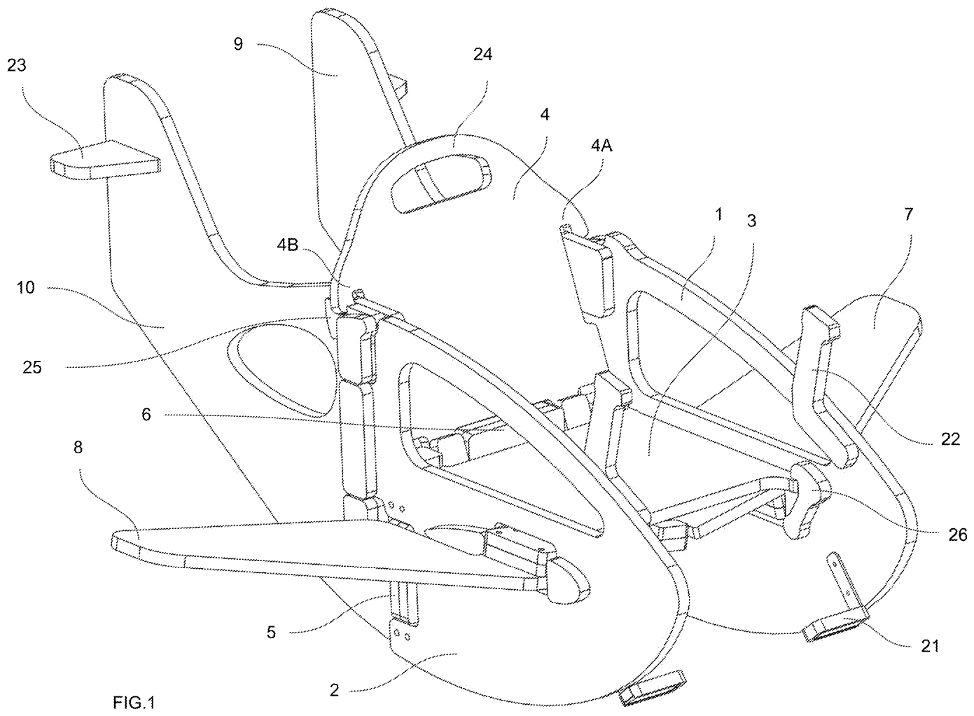

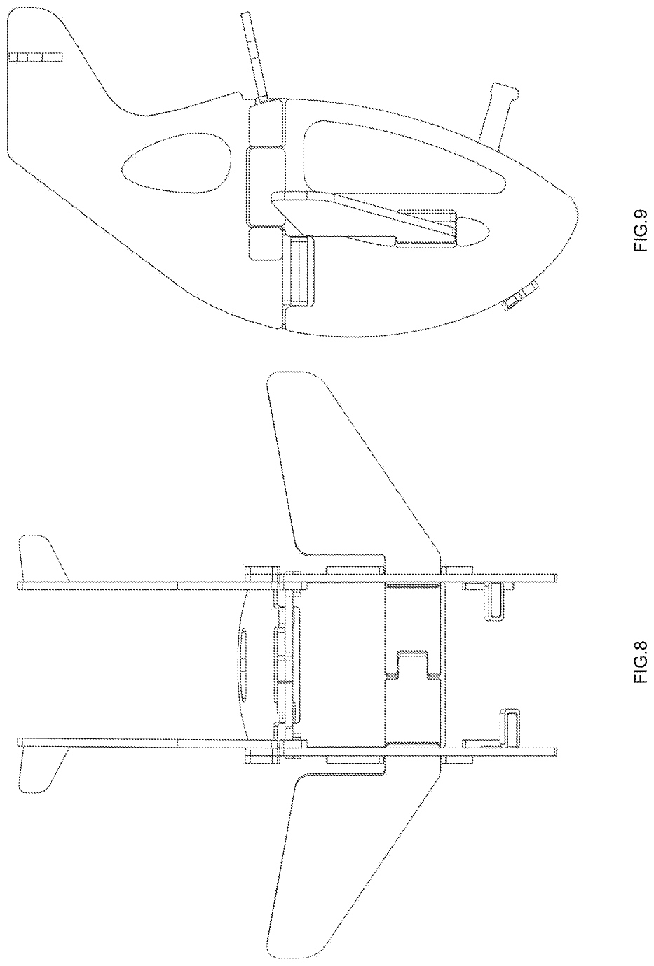

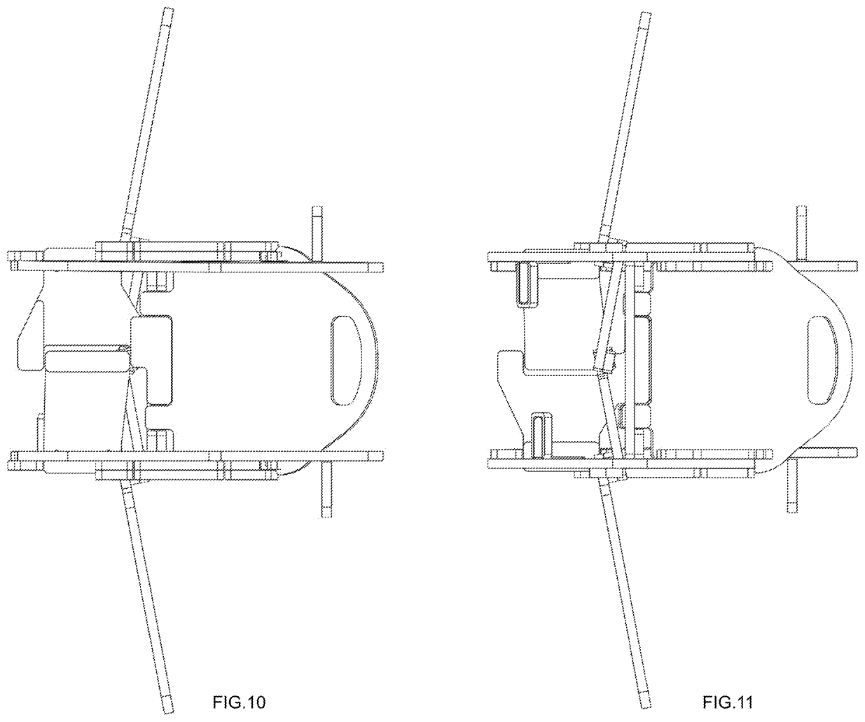

FIGS. 1-13 are diagrams illustrating an exemplary collapsible chair in which some embodiments may operate. The collapsible chair may comprise a left supporting side 1, a right supporting side 2, a seat 3, a backrest 4, a right connecting element 5, a left connecting element 6, a left additional connecting element 7, a right additional connecting element 8, left collapsible back element 9, right collapsible back element 10, a hinge A, a hinge B, a hinge C, a hinge D, a hinge E, a hinge F, a hinge G, a hinge I, a hinge J, a foot rest 21, a handle 22, a winglet 23 and a deployed locking unit 25. Backrest 4 may also comprise a backrest handle 24.

The collapsible chair may be designed to resemble any object. In some embodiments, the collapsible chair may be designed to resemble a transportation device, such as an aircraft. FIGS. 1-13 show an embodiment in which the collapsible chair is designed to resemble an aircraft. The collapsible chair may be any size and scaled up or down for different types of users. For example, the collapsible chair may have one size for children and one size for adults. In other embodiments, there may be a plurality of sizes based on age range, user preference and/or size of the user. In some embodiments, all elements of the collapsible chair may be scaled when changing the size. In some embodiments, a subset of the collapsible chair elements may be scaled when changing the size. For example, the hinges and other hardware used in the construction or fastening of the collapsible chair may be kept the same size, shortened, or modified in a non-proportionate manner, while the body elements of the chair are scaled. In some embodiments, dimensions of all of the components may be modified in a non-proportionate manner. For example, the hinges, additional hardware and body elements of the chair may be shortened in one or more directions while maintaining a standard thickness of the material used. The body elements of all sizes may be of the same thickness so that they may be made from the same base materials.

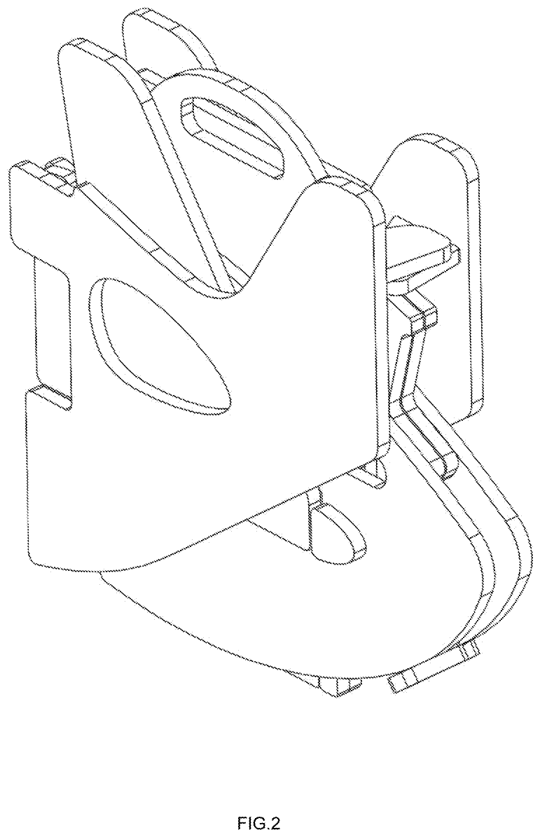

FIG. 1 shows a 3-D view of the collapsible chair in a deployed configuration and FIG. 2 shows a 3-D view of the collapsible chair in a folded configuration.

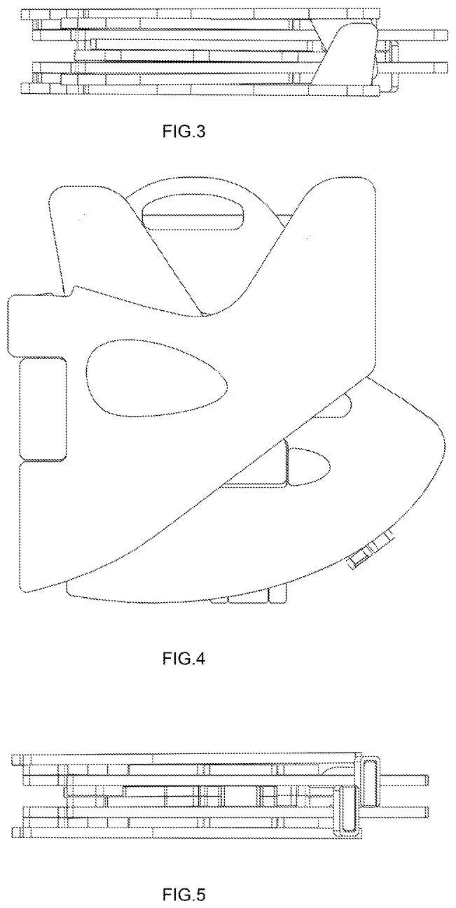

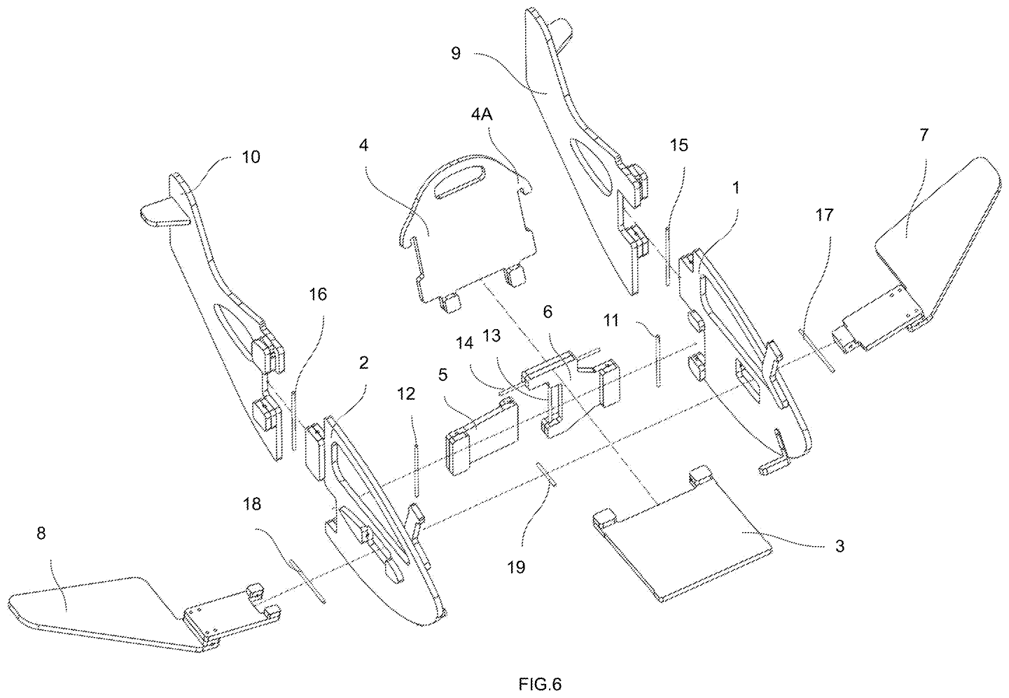

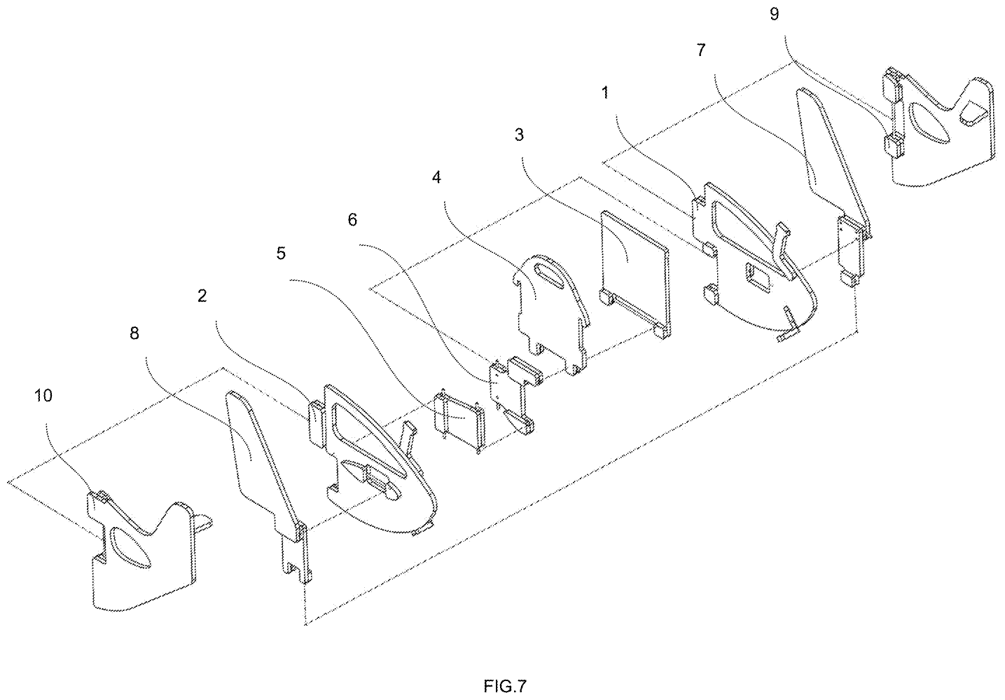

FIGS. 3, 4 and 5 show the collapsible chair in a folded configuration from a top, side and bottom view. FIG. 6 shows an exploded view of the collapsible chair in a deployed configuration. FIG. 7 shows an exploded view of the collapsible chair in a folded configuration.

FIGS. 8-11 show the collapsible chair in a deployed configuration from a bottom, side, back and front view.

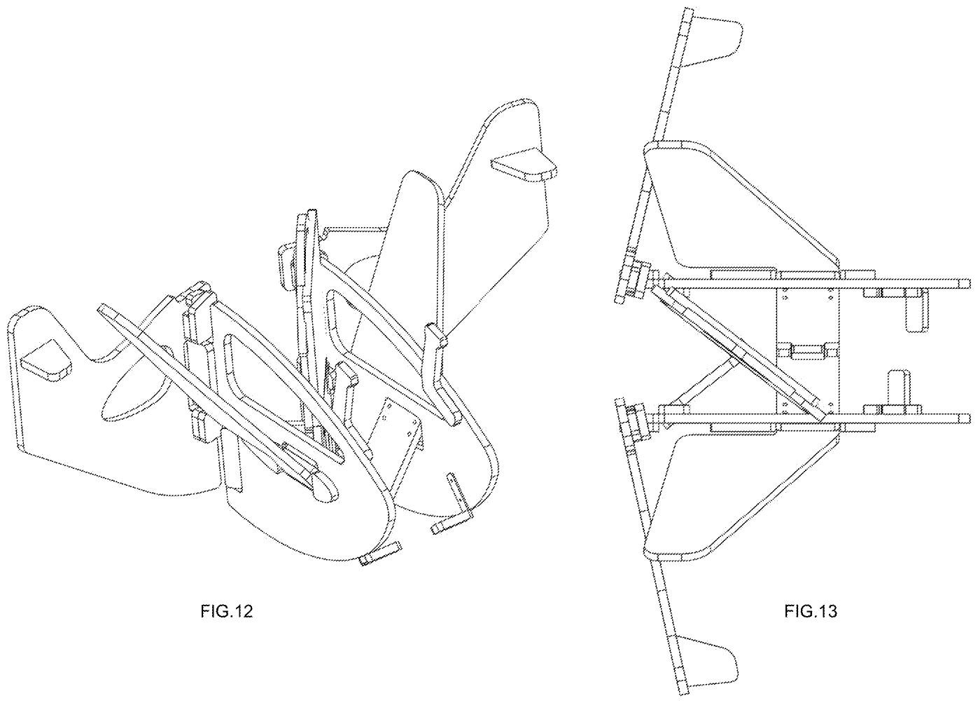

FIGS. 12 and 13 show the collapsible chair in transition from a deployed configuration to a folded configuration. FIG. 12 shows a 3-D view of the collapsible chair in transition and FIG. 13 shows a top view of the collapsible chair in transition.

In some embodiments, the transitioning from the folded configuration to the deployed configuration and from the deployed configuration to the folded configuration may be performed by rotating the chair about the hinges A-J. In some embodiments, the seat 3 and the backrest 4 may be hinged together at hinge D. In some embodiments, the seat may be hinged at hinge D 14 and the backrest 4 hinged at hinge H. Both hinge D 14 and hinge H may be attached to the left connecting element 6. The seat 3 maybe rotate about hinge D 14 to a vertical position in contact and parallel to the backrest 4. The backrest 4 and the seat 3 may then be rotated about a hinge A 11 to facilitate the bringing together of the left supporting side 1 and the right supporting side 2. During the rotation about hinge A 11, the right connecting element 5 may rotate at both hinge B 12 and hinge C 13. The left additional connecting element 7 and the right additional connecting element 8 may simultaneously rotate around their connecting points with the left supporting side 1 (hinge E 17) and the right supporting side 2 (hinge F 18) and hinge G 19, where the left additional connecting element 7 and the right additional connecting element 8 connect with one another. The left collapsible back element 9 and the right collapsible back element 10 may rotate away from one another at hinge I 15 and hinge J 16. The rotation of the left collapsible back element 9 and the right collapsible back element 10 may be configured to rotate from a position colinear to the left supporting side 1 and the right supporting side 2, to a position that is parallel. In some embodiments, the parallel positioning may be a position in which the elements are in contact with one another or at a small offset from one another.

FIGS. 12 and 13 show the chair with a right locking slot 4B and left locking slot 4A of the backrest 4 disengaged from the back element locking unit 25. The back element locking unit 25 may be configured to hold the backrest in the deployed configuration. The backrest 4 may comprise a right locking slot 4B and a left locking slot 4A. In some embodiments, the backrest 4 may include a single locking slot or more than two locking slots. The left locking slot 4A may be oriented perpendicular to, and overlapping the left collapsible back element when in the deployed configuration, rigidly joining the two pieces. The right locking slot 4B may be oriented perpendicular to, and overlapping the right collapsible back element when in the deployed configuration, rigidly joining the two pieces. When in the deployed configuration, the left and right locking slots may be configured to straddle a portion of the left and right collapsible back elements and rest against the back element locking unit 25. The back element locking units 25 may be placed at a position on the right and left collapsible back elements 9 and 10, such that the backrest 4 comes into contact with the back element locking units 25 while the portion of the left and right collapsible back elements 9 and 10 are contacted on three sides by the right and left locking slots. The chair may further comprise a seat locking unit 26 configured to hold the seat in the deployed configuration, preventing a scissoring movement. In some embodiments, there may be more than one seat locking units 26.

As shown in FIGS. 12 and 13, backrest 4 has been rotated forward to an unlocked (vertical) position at the same time the seat locking unit 26 has been disengaged to allow the seat 3 to be rotated to a vertical position to meet the backrest. Upon both the seat 3 and backrest 4 being rotated about a first axis to a vertical position, they may then be rotated about a second axis perpendicular to the first axis to facilitate the transitioning of the chair to the folded configuration.

In some embodiments, the seat locking unit 26 may comprise a spring loaded elbow latch, a spring bolt latch, a swing latch, a hook latch or a draw latch. The seat locking unit 26 may also comprise one or more pins, springs and/or clamping mechanisms. In some embodiments, the chair may further comprise a left additional connecting element 7 and a right additional connecting element 8. The left additional connecting element 7 may be pivotally connected to the left supporting side 1 with hinge E 17. The right additional connecting element 10 may be pivotally connected to the right supporting side 2 with hinge F 18. In some embodiments, hinge G 19, may be configured to pivotally connect the left additional connecting element 7 and the right additional connecting element 8. Hinge G 19 may also be substantially parallel and equidistant to hinge E 17 and hinge F 18. Hinge G 19 may also be oriented horizontally at a midpoint between the left supporting side 1 and the right supporting side 2.

In some embodiments, the chair may be configured to transition from the deployed configuration to a folded configuration by performing a series of steps. The first step may comprise unlocking the seat 3 and backrest 4, wherein the unlocking may further comprise: moving the backrest 4 from a reclined position to a vertical position, and wherein the right locking slot 4B and the left locking slot 4A may hold the right collapsible back element 10 and the left collapsible back element 9 when in the deployed position. The right locking slot 4B and the left locking slot 4A may release the right collapsible back element 10 and left collapsible element 9 when transitioning to the folded configuration.

The second step may comprise disengaging the seat locking unit 26.

The third step may comprise folding the seat 3 to a vertical position parallel to the backrest 4.

The fourth step may comprise rotating the seat 3 and backrest 4 about hinge A 11 at the same time as rotating the left additional connecting element 7 about hinge F 17 and hinge G 19.

This fourth step may cause the simultaneous movement of the left supporting side 1, right supporting side 2, seat 3, backrest 4, right connecting element 5, left connecting element 6. left additional connecting element 7 and right additional connecting element 8. The simultaneous movements may comprise the following:

1. Bringing the left supporting side 1 and the right supporting side 2 towards one another and parallel to the seat 3 and backrest 4 as well as rotate the left additional connecting element 7 to be parallel and in contact with the left supporting side 1 in a vertical position.

2. Rotating the right additional connecting element 8 to be parallel and in contact with the right supporting side 2 in a vertical position.

3. Rotating the left connecting element 6 about hinge A 11 and hinge C 13, and rotating the right connecting element 5 about hinge B 12 and hinge C 13 to bring the right connecting element 5 and left connecting element 6 into a position parallel and in contact with one another.

The fifth step may comprise rotating the left collapsible back element 9 and the right collapsible back element 10 to a position parallel and in contact with the left additional connecting element 7 and the right additional connecting element 8, wherein the left collapsible back element 9 and the right collapsible back element 10 may be configured to rotate independently from the left supporting side 1 and the right supporting side 2.

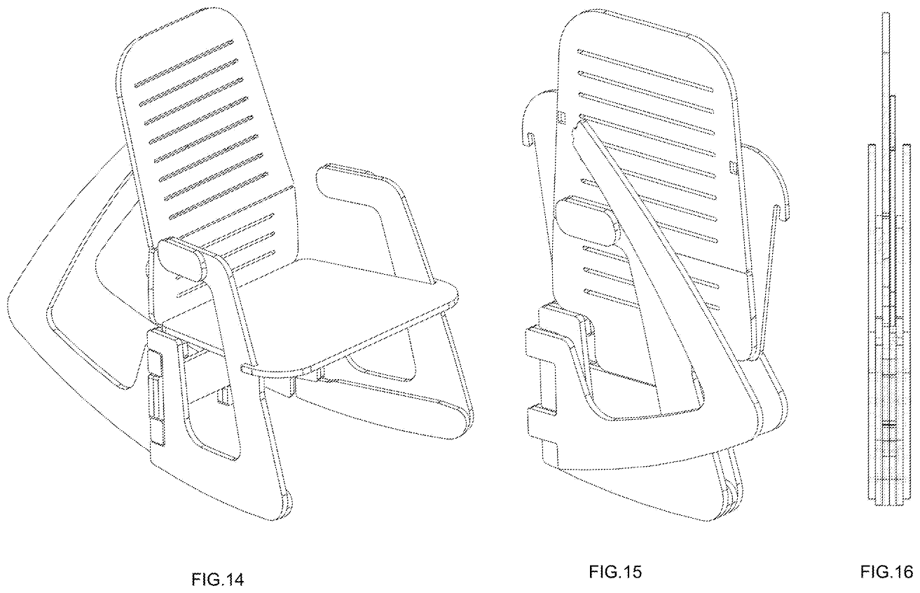

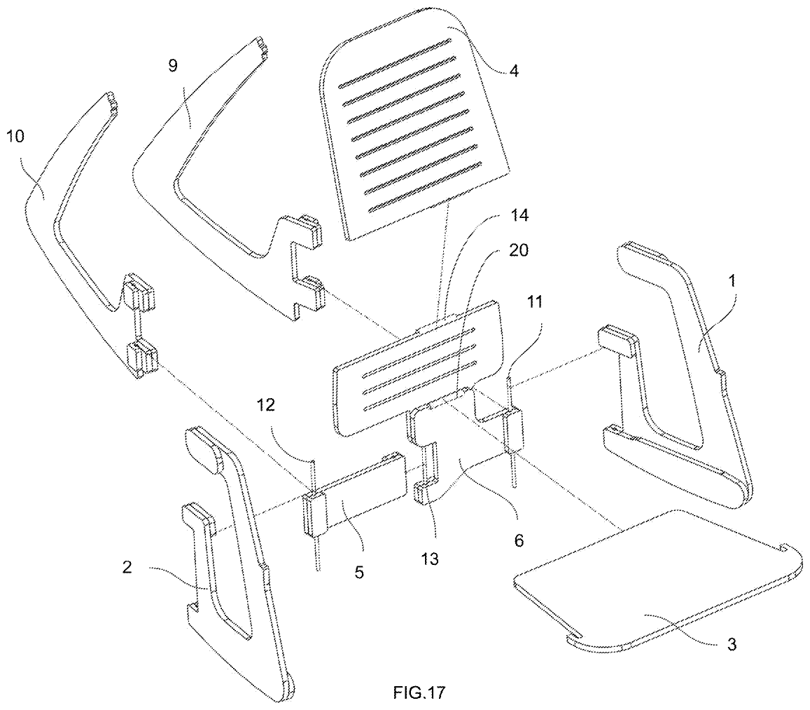

FIGS. 14-18 are diagrams illustrating an exemplary second collapsible chair in which some embodiments may operate. FIGS. 14 and 15 show the second collapsible chair, from a 3-D view, in a deployed configuration and a folded configuration. FIG. 16 shows a front view of the second collapsible chair in the folded configuration.

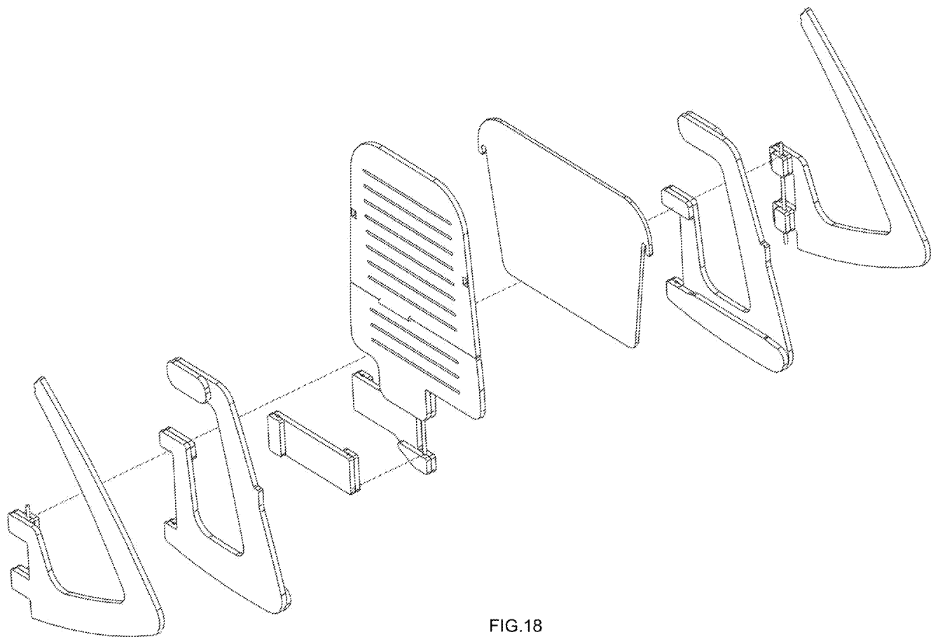

FIG. 17 shows a 3-D exploded view of the second collapsible chair and FIG. 18 shows a 3-D exploded view of the second collapsible chair in a folded configuration. As shown in FIG. 17, the second collapsible chair may comprise a left supporting side 1, a right supporting side 2, a seat 3, a backrest 4, a right connecting element 5, a left connecting element 6, a left additional connecting element 7, a right additional connecting element 8, left collapsible back element 9, right collapsible back element 10, a hinge A 11, a hinge B 12, a hinge C 13, a hinge D 14, a hinge E 15 and a hinge K 20. The second collapsible chair may further comprise a backrest joining member, between the backrest 4 and the left connecting element 6. In some embodiments, the backrest joining member may be pivotally connected to the left connecting element 6 through hinge K 20. Hinge K 20 may connect to the left connecting element 6 in a similar manner to that of hinge D 14 of the first collapsible chair in FIGS. 1-13, specifically FIGS. 6 and 7. In some embodiments, the backrest joining member may pivotally attach to the backrest 4 through hinge D 14. The backrest 4 may be configured to recline in deployed configuration, while the backrest joining member remains vertical. In some embodiments, the backrest joining member may be angled at an angle that is the same as the backrest 4 so as to allow both the backrest joining member and the backrest 4 to be in a coplanar configuration. The backrest joining member may also be rotated about hinge K 20, so as to form an angle that is greater, less than, or the same as the backrest 4.

In some embodiments, the backrest 4 may be configured to lock the second collapsible chair into a deployed configuration through contact with the left collapsible back element 9 and right collapsible back element 10. The left collapsible back element 9 and right collapsible back element 10 may further comprise one or more tenons or fingers configured to interlock with one or more mortises, fingers, or slots on the back of the backrest 4.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A collapsible chair for kids and adults, at least comprising:
a left supporting side(1);
a right supporting side(2);
a left connecting element(6);
a right connecting element(5);
a seat(3);
a backrest(4);
a hinge A (11), wherein the hinge A (11) is configured to pivotally connect the left connecting element (6) to the left supporting side (1) about an axis A;
a hinge B (12), wherein the hinge B (12) is configured to pivotally connect the right connecting element(5) to the right supporting side(2);
a hinge C (13), wherein the hinge C (13) is configured to pivotally connect the left connecting element (6) to the right connecting element(5), and wherein the hinge C (13) is substantially parallel and equidistant from the hinge A (11) and the hinge B (12) and oriented vertically;
a hinge D (14), wherein the hinge D (14) is configured to pivotally connect a main connecting element to the seat (3), wherein main connecting element is either the right connecting element (5) or the left connecting element (6), and wherein the hinge D (14) is substantially perpendicular to the hinge A (11) and the hinge B (12) when the chair is in a deployed configuration, and wherein the hinge D (14) is oriented horizontally; and
a hinge H, wherein the hinge H is configured to pivotally connect the backrest (4) to the main connecting element, and wherein the hinge H is substantially parallel to hinge D (14).

2. The chair of claim 1, wherein the left supporting side (1) comprises a left lower supporting member and the right supporting side (2) comprises a right lower supporting member, wherein the left lower supporting member and right lower supporting member are in contact with the ground have an elliptical shape that enables a rocking movement when in use.

3. The chair of claim 2, wherein the left supporting side (1) comprises a left collapsible back element (9), and wherein the left collapsible back element (9) is articulated with a substantially vertical hinge I (15); and
wherein the right supporting side (2) comprises a right collapsible back element (10), and wherein the right collapsible back element (10) is articulated with a substantially vertical hinge J (16).

4. The chair of claim 3, wherein the chair further comprises a back element locking unit (25), wherein the back element locking unit (25) is configured to hold the backrest (4) in the deployed configuration; and
a seat locking unit (26) configured to hold the seat (3) in the deployed configuration, preventing a scissoring movement.

5. The chair of claim 4, wherein the backrest (4) further comprises a right locking slot (4B) and a left locking slot (4A);
wherein the left locking slot (4A) is oriented perpendicular to, and overlapping the left collapsible back element (9) when in the deployed configuration, rigidly joining the two pieces; and
wherein the right locking slot (4B) is oriented perpendicular to, and overlapping the right collapsible back element (10) when in the deployed configuration, rigidly joining the two pieces.

6. The chair of claim 5, wherein the seat locking unit (26) comprises:
a spring loaded elbow latch;
a spring bolt latch;
a swing latch;
a hook latch; or
a draw latch.

7. The chair of claim 6, wherein the chair further comprises:
a left additional connecting element (7), wherein the left additional connecting element (7) is pivotally connected to the left supporting side (1) with hinge E (17);
a right additional connecting element (8), wherein the right additional connecting element (8) is pivotally connected to the right supporting side (2) with hinge F (18); and
a hinge G (19), wherein the hinge G (19) is configured to pivotally connect the left additional connecting element (7) and the right additional connecting element (8), and wherein the hinge G (19) is substantially parallel and equidistant to the hinge E (17) and hinge F (18), and wherein the hinge G (19) is oriented horizontally.

8. The chair of claim 7, wherein the chair is configured to transition from the deployed configuration to a folded configuration by performing the steps of:
Unlocking the seat (3) and backrest (4), wherein the unlocking comprises:
moving the backrest (4) from a declined position to a vertical position, wherein the right locking slot (4B) and the left locking slot (4A) are hold the right collapsible back element (10) and the left collapsible back element (9) when in the deployed position and the right locking slot (4B) and the left locking slot (4A) release the right collapsible back element (10) and left collapsible element (9) when transitioning to the folded configuration;
disengaging the seat locking unit (26); and
folding the seat (3) to a vertical position parallel to the backrest (4); and
transitioning the chair into the folded configuration, wherein the transitioning comprises:
rotating the seat (3) and backrest (4) about hinge A (11) at the same time as rotating the left additional connecting element (7) about hinge F (18) and hinge G (19), wherein the transitioning is further configured to simultaneously:
bring the left supporting side (1) and the right supporting side (2) towards one another and parallel to the seat (3) and backrest (4);
rotate the left additional connecting element (7) to be parallel and in contact with the left supporting side (1) in a vertical position;
rotate the right additional connecting element (8) to be parallel and in contact with the right supporting side (2) in a vertical position; and
rotate the left connecting element(6) about hinge A (11) and hinge C (13) and rotate the right connecting element (5) about hinge B (12) and hinge C (13) to bring the right connecting element (5) and left connecting element (6) into a position parallel and in contact with one another; and
rotating the left collapsible back element (9) and the right collapsible back element (10) to a position parallel and in contact with the left additional connecting element (7) and the right additional connecting element (8), wherein the left collapsible back element (9) and the right collapsible back element (10) are configured to rotate independently from the left supporting side (1) and the right supporting side (2).

9. The chair of claim 8, wherein the left additional connecting element (7) is further configured to extend past the left supporting side (1); and
wherein the right additional connecting element (8) is further configured to extend past the right supporting side (2);

10. The chair of claim 1, wherein the backrest (4) comprises a handle that facilitates the transport in both a folded configuration and the deployed configuration.

11. The chair of claim 3, wherein the left collapsible back element (9) and right collapsible back element (10) both comprise a winglet (23) and wherein the left collapsible back element (9) and right collapsible back element (10) can be locked together with the winglets (23) when the chair is in its folded configuration to prevent opening the chair into the deployed configuration.

12. The chair of claim 1, wherein the left supporting side (1), right supporting side (2), seat (3), backrest (4), right connecting element (5), left connecting element (6), left additional connecting element (7), right additional connecting element (8), left collapsible back element (9) and right collapsible back element (10) are made of wood;
hinge A (11), hinge B (12), hinge C (13), hinge D (14), hinge E (17), hinge F (18), hinge G (19), hinge H, hinge I (15) and hinge J (16) are made of metal; and
wherein the chair further comprises additional components, wherein the additional components include bushings and washers, and wherein the additional components are made of plastic and are inserted between components made of metal and components made of wood to avoid creaking and create controlled friction in the plurality of hinges.

13. The chair of claim 12, wherein the wood is a 3-axis CNC machined plywood.

14. The chair of claim 12, wherein the metal is stainless steel.

15. The chair of claim 1, wherein the left supporting element (1) and right supporting element (2) each comprise a handle (22) and a foot rests (21).

16. The chair of claim 1, wherein the chair is designed to have the shape of a transportation device.

17. The chair of claim 1, wherein the chair is designed to have the shape of an aircraft or an animal.

18. The chair of claim 1, wherein the chair in a folded configuration can fit in a box with dimensions of 19 inches by 19 inches by 5 inches, or 1 cuft, and weigh less than 16 lbs, for a minimal storage space and standard ground shipping in the US.
